(19) United States
(12) Patent Application Publication
(10) Pub. No.: US 2025/0151046 A1
(43) Pub. Date: May 8, 2025

(54) METHOD AND APPARATUS FOR PUCCH TRANSMISSION

(71) Applicant: LENOVO (BEIJING) LIMITED, BEIJING (CN)

(72) Inventors: RUIXIANG MA, BEIJING (CN); YUANTAO ZHANG, BEIJING (CN); HONGMEI LIU, BEIJING (CN); ZHI YAN, BEIJING (CN); HAIMING WANG, BEIJING (CN)

(21) Appl. No.: 18/726,104

(22) PCT Filed: Dec. 31, 2021
(86) PCT No.: PCT/CN2021/143636

§ 371 Date: Jul. 1, 2024

(51) Int. Cl. H04W 72/11; H04L 1/1812; H04L 1/1829; H04W 72/0453; H04W 72/1273; H04W 72/21

(52) U.S. Cl. CPC H04W 72/11; H04L 1/1812; H04L 1/1854; H04W 72/0453; H04W 72/1273; H04W 72/21

(57) ABSTRACT

According to some embodiments of the disclosure, a user equipment (UE) may: determine a first physical uplink control channel (PUCCH) resource for a first PUCCH transmission in a first time unit, wherein the first PUCCH transmission carries hybrid automatic repeat request acknowledgement (HARQ-ACK) information bits for at least one semi-persistent scheduling (SPS) physical downlink shared channel (PDSCH) reception, and the first PUCCH resource is on a first frequency domain part; and in the event that the first PUCCH resource overlaps a symbol not intended for an uplink transmission on a second frequency domain part, defer the first PUCCH transmission.

### TECHNICAL FIELD

Embodiments of the present disclosure generally relate to wireless communication technology, and more particularly to a physical uplink control channel (PUCCH) transmission.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, data can be transmitted from a base station (BS) to a user equipment (UE) via a physical downlink shared channel (PDSCH). The PDSCH may be a dynamic PDSCH scheduled by downlink control information (DCI) via a corresponding physical downlink control channel (PDCCH) or a semi-persistent scheduling (SPS) PDSCH. The UE may transmit hybrid automatic repeat request acknowledgement (HARQ-ACK) feedback corresponding to the PDSCH transmission through a PUCCH or a physical uplink shared channel (PUSCH).

The industry desires technologies for facilitating a PUCCH transmission carrying HARQ-ACK feedback in a communication system.

### SUMMARY

Some embodiments of the present disclosure provide a user equipment (UE). The UE may include: a memory, a transceiver; and a processor coupled to the memory and to the transceiver. The processor may be configured to cause the UE to: determine a first physical uplink control channel (PUCCH) resource for a first PUCCH transmission in a first time unit, wherein the first PUCCH transmission carries hybrid automatic repeat request acknowledgement (HARQ-ACK) information bits for at least one semi-persistent scheduling (SPS) physical downlink shared channel (PDSCH) reception, and the first PUCCH resource is on a first frequency domain part; and in the event that the first PUCCH resource overlaps a symbol not intended for an uplink transmission on a second frequency domain part, defer the first PUCCH transmission.

Some embodiments of the present disclosure provide a user equipment (UE). The UE may include: a memory; a transceiver; and a processor coupled to the memory and to the transceiver. The processor may be configured to cause the UE to: determine a physical uplink control channel (PUCCH) resource for transmitting a deferred PUCCH transmission in a time unit, wherein the deferred PUCCH transmission carries at least a part of hybrid automatic repeat request acknowledgement (HARQ-ACK) information bits for at least one semi-persistent scheduling (SPS) physical downlink shared channel (PDSCH) reception before the time unit, and the PUCCH resource is on a first frequency domain part; and in the event that the PUCCH resource does not overlap a symbol not intended for an uplink transmission on a second frequency domain part, transmit the deferred PUCCH transmission on the PUCCH resource.

Some embodiments of the present disclosure provide a method for wireless communication performed by a user equipment (UE). The method may include: determining a first physical uplink control channel (PUCCH) resource for a first PUCCH transmission in a first time unit, wherein the first PUCCH transmission carries hybrid automatic repeat request acknowledgement (HARQ-ACK) information bits for at least one semi-persistent scheduling (SPS) physical downlink shared channel (PDSCH) reception, and the first PUCCH resource is on a first frequency domain part; and in the event that the first PUCCH resource overlaps a symbol not intended for an uplink transmission on a second frequency domain part, deferring the first PUCCH transmission.

Some embodiments of the present disclosure provide a method for wireless communication performed by a user equipment (UE). The method may include: determining a physical uplink control channel (PUCCH) resource for transmitting a deferred PUCCH transmission in a time unit, wherein the deferred PUCCH transmission carries at least a part of hybrid automatic repeat request acknowledgement (HARQ-ACK) information bits for at least one semi-persistent scheduling (SPS) physical downlink shared channel (PDSCH) reception before the time unit, and the PUCCH resource is on a first frequency domain part; and in the event that the PUCCH resource does not overlap a symbol not intended for an uplink transmission on a second frequency domain part, transmitting the deferred PUCCH transmission on the PUCCH resource.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an exemplary SPS PDSCH transmission in accordance with some embodiments of the present disclosure;

FIG. 3 illustrates an exemplary PUCCH transmission in accordance with some embodiments of the present disclosure;

FIG. 4 illustrates an exemplary sub-band full duplex scheme in accordance with some embodiments of the present disclosure;

FIG. 5 illustrates an exemplary PUCCH transmission when carrier aggregation (CA) is configured in accordance with some embodiments of the present disclosure;

FIG. 6 illustrates an exemplary PUCCH transmission in a subband in accordance with some embodiments of the present disclosure;

FIGS. 7 and 8 illustrate examples for target PUCCH resource determination in accordance with some embodiments of the present disclosure;

FIG. 9 illustrates a flow chart of an exemplary procedure of wireless communications in accordance with some embodiments of the present disclosure;

FIG. 10 illustrates a flow chart of an exemplary procedure of wireless communications in accordance with some embodiments of the present disclosure; and

FIG. 11 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

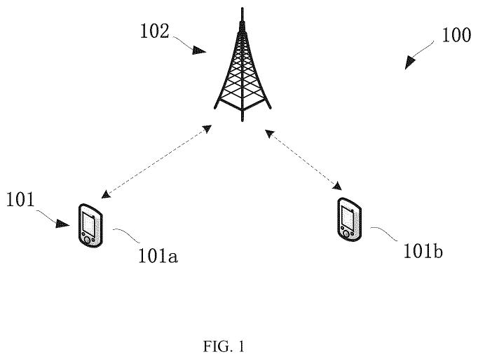

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, a UE may receive a DCI for activating an SPS configuration from one or more SPS configurations. For each SPS configuration, a period P and a PUCCH resource indicator (e.g., n1PUCCH-AN as specified in 3GPP specifications) may be provided. In addition, the DCI may indicate the time domain resource and frequency domain resource of a PDSCH for the activated SPS configuration and indicate the slot for the PUCCH transmission. For example, the DCI may indicate a slot offset (denoted as K1) between the SPS PDSCH and the PUCCH transmission. For instance, assuming that an SPS PDSCH reception ends in slot n, the PUCCH transmission carrying the HARQ-ACK feedback for the SPS PDSCH can be within slot n+K1.

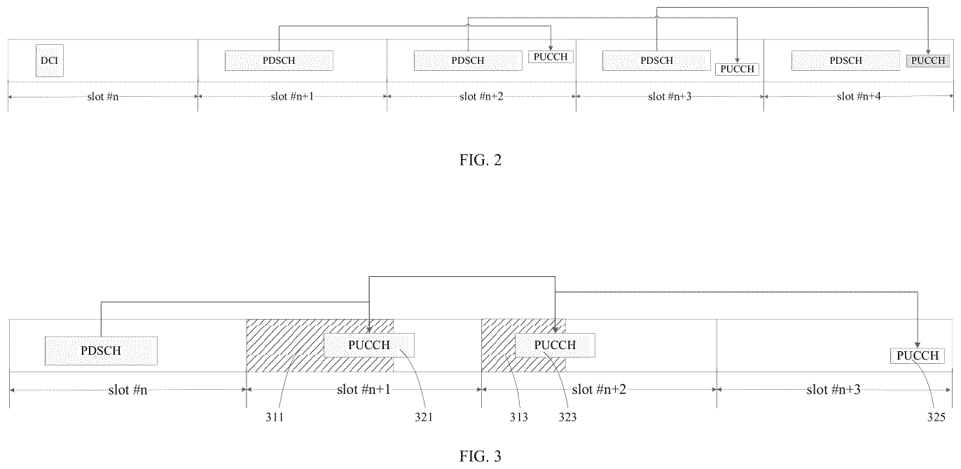

FIG. 2 illustrates an exemplary SPS PDSCH transmission in accordance with some embodiments of the present disclosure. In some examples, four SPS configurations indexed from 0 to 3 may be configured. Referring to FIG. 2, a UE may receive a DCI in slot #n indicating that SPS configuration 1 is activated. Assuming that the period of SPS configuration 1 is 1 slot (i.e., P1=1 slot), one SPS PDSCH reception may occur per slot. The DCI may further indicate the time domain resource and frequency domain resource of the PDSCHs for the activated SPS configuration as shown in FIG. 2. Moreover, assuming that the DCI indicates that K1=1, the corresponding HARQ-ACK feedback for each SPS PDSCH reception may be transmitted on a PUCCH transmission within the next slot of the SPS PDSCH transmission.

In some embodiments of the present disclosure, a UE may be provided by a higher layer (e.g., RRC) signaling a list of PUCCH resources (e.g., SPS-PUCCH-AN-List) for HARQ-ACK feedback corresponding to SPS PDSCHs. The UE may select a PUCCH resource from the list of PUCCH resources for transmitting HARQ-ACK feedback corresponding to the SPS PDSCHs in a slot (e.g., slot n+K1). In some examples, the UE may determine the PUCCH resource based on the number of HARQ-ACK feedback information bits to be transmitted in the slot. Other methods may also be applied for the PUCCH resource determination.

In some embodiments of the present disclosure, a UE may be provided with at least one set of PUCCH resources (e.g., by PUCCH-Config) for HARQ-ACK feedback corresponding to SPS PDSCHs and HARQ-ACK feedback corresponding to other types of PDSCHs (e.g., a PDSCH dynamically scheduled by a DCI) in a slot (e.g., slot n+K1). The UE may first select a PUCCH resource set from the at least one set of PUCCH resources and then select a PUCCH resource from the selected PUCCH resource set for transmitting the HARQ-ACK feedback. In some examples, the UE may select the PUCCH resource set based on the number of HARQ-ACK feedback information bits to be transmitted. The UE may select the PUCCH resource from the selected PUCCH resource set based on, for example, a PUCCH resource indicator in the last transmitted DCI among the DCIs that schedules PDSCHs with corresponding HARQ-ACK feedback to be transmitted in the same slot as the SPS PDSCHs. Other methods may also be applied for the PUCCH resource determination.

In some embodiments of the present disclosure, a PUCCH may overlap a PUSCH. In some examples, the HARQ-ACK feedback in the PUCCH may be multiplexed in the PUSCH. In some embodiments, a priority may be configured for an SPS configuration to determine the priority of the HARQ-ACK feedback for the corresponding SPS PDSCH(s). In some examples, only the HARQ-ACK feedback corresponding to the same priority can be transmitted in the same PUCCH. In some embodiments, for a dynamically scheduled PDSCH or PUSCH, the DCI scheduling the PDSCH or PUSCH may provide a priority for the HARQ-ACK feedback of the PDSCH or PUSCH. In some examples, only the PUCCH or PUSCH with the same priority can be transmitted together. In some embodiments, when a higher priority PUCCH or PUSCH overlaps a lower priority PUCCH or PUSCH, only the higher priority PUCCH or PUSCH can be transmitted and the lower priority PDSCH or PUSCH may be dropped.

However, an SPS PDSCH may carry ultra-reliable low latency communication (URLLC) traffic which requires ultra-low latency and high reliability. When the HARQ-ACK feedback for an SPS PDSCH is dropped, a BS may retransmit the SPS PDSCH and wait for the HARQ-ACK feedback, which would increase latency and cause resources to be wasted.

Embodiments of the present disclosure provide solutions for deferring the HARQ-ACK feedback transmission for an SPS PDSCH(s). For example, the HARQ-ACK feedback transmission for an SPS PDSCH(s) can be deferred until a next available PUCCH if it is dropped due to certain conditions. More details on the embodiments of the present disclosure will be illustrated in the following text in combination with the appended drawings.

In some embodiments of the present disclosure, a UE may perform a procedure to resolve overlapping among PUCCHs and PUSCHs in a slot (denoted as “slot #A1”). Then, the UE may determine a PUCCH resource for a PUCCH transmission carrying first HARQ-ACK information bits for SPS PDSCH receptions that the UE would report for a first time (e.g., in slot #A1). In some examples, the PUCCH resource may be provided by SPS-PUCCH-AN-List or n1PUCCH-AN as described above.

When the determined PUCCH resource overlaps a symbol for a downlink transmission (e.g., indicated as downlink by a parameter such as tdd-UL-DL-ConfigurationCommon or tdd-UL-DL-ConfigDedicated), overlaps a symbol for receiving a synchronization signal block (SSB) (e.g., indicated for a synchronization signal and physical broadcast channel (SS/PBCH) block by ssb-PositionsInBurst), or overlaps a symbol for receiving a downlink transmission which schedules system information (e.g., belonging to a control resource set (CORESET) associated with a Type0-PDCCH common search space (CSS) set), the UE may defer the PUCCH transmission.

In some embodiments, the UE may determine an earliest target slot (denoted as “slot #A2”) for transmitting the deferred PUCCH transmission. For example, the UE may check from the next slot of slot #A1 per each slot until finding a suitable slot. The target slot should satisfy certain conditions, as will be described below.

After performing the procedure to resolve overlapping among PUCCHs and PUSCHs in slot #A2, the UE may determine a PUSCH or a PUCCH resource in slot #A2 to multiplex HARQ-ACK information bits that include second HARQ-ACK information bits from the first HARQ-ACK information bits. The determined PUCCH resource does not overlap a symbol for a downlink transmission, a symbol for receiving a synchronization signal block (SSB), or a symbol for receiving a downlink transmission which schedules system information. The second HARQ-ACK information bits may be determined based on a HARQ deferral value (such as a value provided by spsHARQdeferral) for an SPS configuration and the time difference between slot #A2 and the slot where a corresponding SPS PDSCH reception is received.

FIG. 3 illustrates an exemplary PUCCH transmission in accordance with some embodiments of the present disclosure. In FIG. 3, after performing the procedure to resolve overlapping among PUCCHs and PUSCHs in slot #n+1, a UE may determine PUCCH resource 321 for a PUCCH transmission with HARQ-ACK information bits (bits #A1) for SPS PDSCH receptions that the UE would report. PUCCH resource 321 may be provided by, for example, SPS-PUCCH-AN-List or n1PUCCH-AN if SPS-PUCCH-AN-List is not provided.

Symbols 311 in slot #n+1 may be indicated as downlink by tdd-UL-DL-ConfigurationCommon or tdd-UL-DL-ConfigDedicated, or indicated for an SS/PBCH block by ssb-PositionsInBurst, or belong to a CORESET associated with a Type0-PDCCH CSS set. PUCCH resource 321 may overlap symbols 311. Accordingly, the UE may defer the PUCCH transmission.

The UE may try to find a target slot for transmitting the HARQ-ACK feedback in the deferred PUCCH. For example, after performing the procedure to resolve overlapping among PUCCHs and PUSCHs in slot #n+2, the UE may determine PUCCH resource 323 to multiplex the deferred HARQ-ACK information bits. However, symbols 313 in slot #n+2 may be indicated as downlink by tdd-UL-DL-ConfigurationCommon or tdd-UL-DL-ConfigDedicated, or indicated for an SS/PBCH block by ssb-PositionsInBurst, or belong to a CORESET associated with a Type0-PDCCH CSS set. PUCCH resource 323 may overlap symbols 313. Therefore, slot #n+2 is not the target slot for transmitting the deferred HARQ-ACK feedback. The UE may continue to find a target slot.

For example, after performing the procedure to resolve overlapping among PUCCHs and PUSCHs in slot #n+3, the UE may determine PUCCH resource 325 to multiplex the deferred HARQ-ACK information bits. PUCCH resource 323 may not overlap a symbol which is indicated as downlink by tdd-UL-DL-ConfigurationCommon or tdd-UL-DL-ConfigDedicated, or indicated for an SS/PBCH block by ssb-PositionsInBurst, or belongs to a CORESET associated with a Type0-PDCCH CSS set. Therefore, slot #n+3 is the target slot for transmitting the deferred HARQ-ACK feedback. The UE may transmit at least a part of bits #A1 on PUCCH resource 323 in slot #n+3. For example, at least a part of bits #A1 may correspond to SPS PDSCH configurations with a HARQ deferral value that is larger than or equal to a time difference between slot #n+3 and slot #3. The time difference may be determined with reference to slots for PUCCH transmissions on the primary cell of the UE.

The above embodiments for deferring the PUCCH transmission only take a single carrier case into consideration. It would be beneficial to take the CA case into consideration. Embodiments of the present disclosure further provide enhanced solutions for deferring the PUCCH transmission in the case of CA, which can effectively reduce latency and avoid wasting radio resources. In addition, embodiments of the present disclosure further provide solutions for determining a target slot for a deferred PUCCH. More details on the embodiments of the present disclosure will be illustrated in the following text in combination with the appended drawings.

Moreover, in order to realize a superior data rate and latency in a wireless system (e.g., 5G system), a spectrum on higher frequency band is inevitable. However, a big question is how to overcome coverage reduction on such carriers. To solve the problem, a duplexing scheme that enables simultaneous use of downlink and uplink within a time division duplex (TDD) carrier using non-overlapped frequency resource (which may be referred to as “sub-band full duplex”) may be employed. The sub-band may refer to a bandwidth part (BWP) of a serving cell of a UE or a part of a BWP of a serving cell of a UE. One intention of this scheme is to extend the duration over which uplink transmission can occur for improving uplink coverage and capacity. For example, a BS may simultaneously perform a downlink transmission and an uplink transmission (for example, to different UEs).

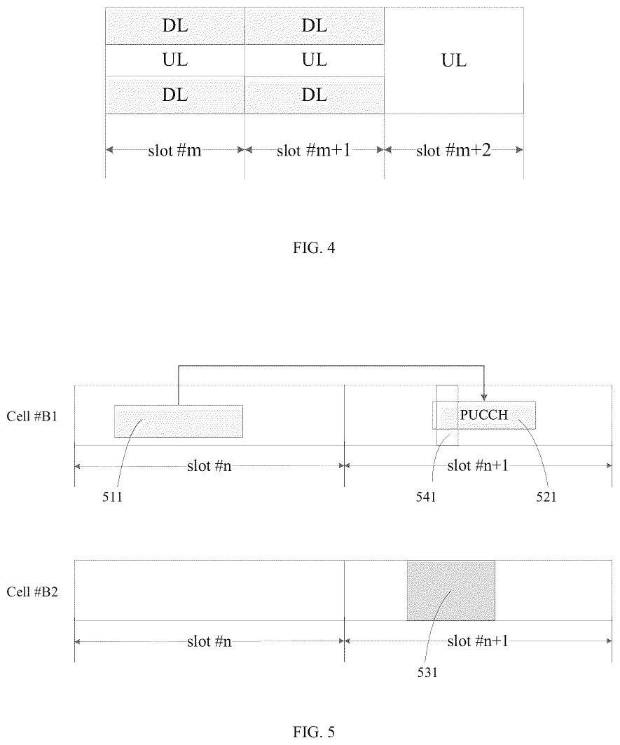

For example, FIG. 4 shows an exemplary sub-band full duplex scheme in accordance with some embodiments of the present disclosure. As shown in FIG. 4, there may be a plurality of transmission directions in a symbol. For example, in slot #m and slot #m+1, two downlink transmission directions and one uplink transmission direction correspond to three sub-bands, respectively. Assuming a PUCCH carrying HARQ-ACK feedback for an SPS PDSCH is determined in slot #m+1, it is unclear whether it should be deferred and how to determine a target slot for the deferred PUCCH.

Embodiments of the present disclosure further provide enhanced solutions for deferring a PUCCH transmission and solutions for determining a target slot for the deferred PUCCH when there are at least two transmission directions in at least two sub-bands corresponding to a symbol of the PUCCH transmission. More details on the embodiments of the present disclosure will be illustrated in the following text in combination with the appended drawings.

In some embodiments of the present disclosure, in the event that a PUCCH carrying HARQ-ACK feedback for an SPS PDSCH on a frequency domain part overlaps a symbol not intended for a UL transmission in another frequency domain part, the PUCCH may be deferred.

For example, in some embodiments of the present disclosure, a UE may be configured with CA and support a half-duplex TDD CA capability. In the event that a PUCCH carrying HARQ-ACK feedback for an SPS PDSCH in a slot on a serving cell (e.g., cell #A1) of the plurality of serving cells of a UE overlaps a symbol not intended for UL transmission in the slot on another serving cell (e.g., cell #A2) of the plurality of serving cells of the UE, the PUCCH may be deferred.

In some embodiments, the symbol not intended for UL transmission may be a symbol configured to receive an SSB on cell #A2. The symbol configured for receiving an SSB may be from a set of symbols that is indicated to the UE for reception of SS/PBCH blocks on cell #A2. For example, the set of symbols may be indicated by ssb-PositionsInBurst in SystemInformationBlockTypel or by ssb-PositionsInBurst in ServingCellConfigCommon, when provided to the UE.

For example, referring to FIG. 5, a UE may be configured with a plurality of serving cells, including for example, cell #B1 and cell #B2. The UE may receive SPS PDSCH 511 in slot #n on cell #B1. After performing the procedure to resolve overlapping among PUCCHs and PUSCHs in slot #n+1, the UE may determine PUCCH resource 521 for a PUCCH transmission with HARQ-ACK feedback for SPS PDSCH 511 that the UE would report for the first time in cell #B1. PUCCH resource 521 may be provided by, for example, SPS-PUCCH-AN-List via higher layer (e.g., RRC) signaling or n1PUCCH-AN if SPS-PUCCH-AN-List is not provided. It should be understood that SPS PDSCH reception 511 and PUCCH resource 521 may be on different cells in some other embodiments of the present disclosure.

In some examples, symbols 531 may be a set of symbols of slot #n+1 that are indicated to the UE for reception of SS/PBCH blocks on cell #B2 by, for example, ssb-PositionsInBurst in SystemInformationBlockTypel or ssb-PositionsInBurst in ServingCellConfigCommon, when provided to the UE. As shown in FIG. 5, since symbols of PUCCH resource 521 overlaps symbols 531, the PUCCH transmission may be deferred.

In some embodiments, the symbol not intended for UL transmission may be a symbol configured for a downlink transmission on cell #A2. The symbol configured for a downlink transmission may be indicated by tdd-UL-DL-ConfigurationCommon or tdd-UL-DL-ConfigurationDedicated. Cell #A2 may be a reference cell. Cell #A1 may be a serving cell of the UE different from the reference cell, which may also be referred to “a non-reference cell”.

The reference cell may be a serving cell of the UE with a relatively higher priority. For a symbol, the UE may determine a reference cell with the smallest cell index among:
the configured plurality of serving cells of the UE when the UE is not capable of simultaneous transmission and reception among the plurality of serving cells; or
the cells of each band respectively when the UE is capable of simultaneous transmission and reception for the configured plurality of serving cells.

For example, referring again to FIG. 5, the UE may determine PUCCH resource 521 for a PUCCH transmission with HARQ-ACK feedback for SPS PDSCH 511 that the UE would report for the first time in cell #B1. For each symbol of PUCCH resource 521, the UE may determine a corresponding reference cell. For example, the UE may determine that cell #B2 is a reference cell for symbol 541. In some examples, symbols 531 may be indicated for a downlink transmission(s) on cell #B2. For example, symbols 531 are indicated as downlink by tdd-UL-DL-ConfigurationCommon or tdd-UL-DL-ConfigurationDedicated on cell #B2. As shown in FIG. 5, since PUCCH resource 521 (e.g., symbol 541) overlaps symbols 531, the PUCCH transmission may be deferred.

In some embodiments, the symbol not intended for UL transmission may be a symbol configured to receive a downlink transmission on cell #A2. For example, the symbol may be configured by a higher layer(s) (e.g., RRC) to receive a PDCCH, a PDSCH, or a channel state information reference signal (CSI-RS) on a reference cell. That is, cell #A2 may be a reference cell, and cell #A1 may be a serving cell of the UE different from the reference cell.

For example, referring again to FIG. 5, the UE may determine PUCCH resource 521 for a PUCCH transmission with HARQ-ACK feedback for SPS PDSCH 511 that the UE would report for the first time on cell #B1. The UE may determine that cell #B2 is a reference cell for symbol 541. In some examples, symbols 531 may be configured to receive a downlink transmission (e.g., a PDCCH, a PDSCH, or a CSI-RS) on cell #B2. As shown in FIG. 5, since PUCCH resource 521 (e.g., symbol 541) overlaps symbols 531, the PUCCH transmission may be deferred.

In some embodiments of the present disclosure, when the sub-band full duplex scheme is employed, in the event that a PUCCH carrying HARQ-ACK feedback for an SPS PDSCH on a sub-band (e.g., sub-band #A1) overlaps a symbol not intended for UL transmission on another sub-band (e.g., sub-band #A2), the PUCCH may be deferred. A sub-band may be a BWP of a serving cell of a UE or a part of a BWP of a serving cell of the UE.

In some embodiments, the symbol not intended for UL transmission may be a symbol configured to receive an SSB on sub-band #A2. The symbol configured for receiving an SSB may be from a set of symbols that is indicated to the UE for reception of SS/PBCH blocks on sub-band #A2 by higher layer signaling.

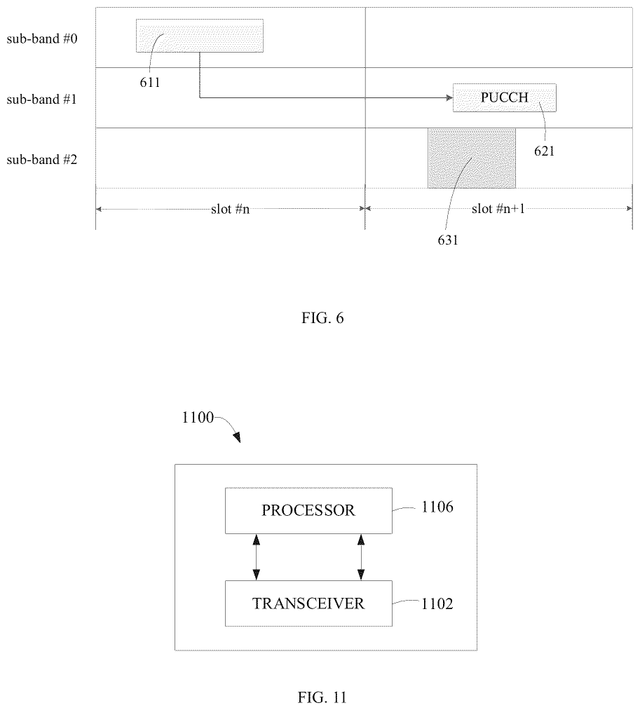

For example, referring to FIG. 6, the BWP(s) of a serving cell of a UE may be divided into a plurality of sub-bands, including for example, sub-band #0, sub-band #1, and sub-band #2. The UE may receive SPS PDSCH 611 in slot #n on sub-band #0. After performing the procedure to resolve overlapping among PUCCHs and PUSCHs in slot #n+1, the UE may determine PUCCH resource 621 for a PUCCH transmission with HARQ-ACK feedback for SPS PDSCH 611 that the UE would report for the first time in sub-band #1. PUCCH resource 621 may be provided by, for example, SPS-PUCCH-AN-List via higher layer (e.g., RRC) signaling or n1PUCCH-AN if SPS-PUCCH-AN-List is not provided. It should be understood that SPS PDSCH reception 611 and PUCCH resource 621 may be on different sub-bands in some other embodiments of the present disclosure.

In some examples, symbols 631 may be a set of symbols of slot #n+1 that are indicated to the UE for reception of SS/PBCH blocks on sub-band #2. As shown in FIG. 6, since symbols of PUCCH resource 621 overlaps symbols 631, the PUCCH transmission may be deferred.

In some embodiments, the symbol not intended for UL transmission may be a symbol configured for a downlink transmission on sub-band #A2. The symbol configured for a downlink transmission may be indicated by tdd-UL-DL-ConfigurationCommon or tdd-UL-DL-ConfigurationDedicated.

For example, referring again to FIG. 6, the UE may determine PUCCH resource 621 for a PUCCH transmission with HARQ-ACK feedback for SPS PDSCH 611 that the UE would report for the first time in sub-band #1. In some examples, symbols 631 may be indicated for a downlink transmission(s) on sub-band #2. For example, symbols 631 are indicated as downlink by tdd-UL-DL-ConfigurationCommon or tdd-UL-DL-ConfigurationDedicated on sub-band #2. As shown in FIG. 6, since PUCCH resource 621 overlaps symbols 631, the PUCCH transmission may be deferred.

In some embodiments, the symbol not intended for UL transmission may be a symbol configured to receive a downlink transmission on sub-band #A2. For example, the symbol may be configured by a higher layer(s) (e.g., RRC) to receive a PDCCH, a PDSCH, or a CSI-RS on sub-band #A2. In some embodiments, the symbol not intended for UL transmission may be a symbol belonging to a CORESET associated with a Type0-PDCCH CSS set on sub-band #A2.

For example, referring again to FIG. 6, the UE may determine PUCCH resource 621 for a PUCCH transmission with HARQ-ACK feedback for SPS PDSCH 611 that the UE would report for the first time on sub-band #1. In some examples, symbols 631 may be configured to receive a downlink transmission (e.g., a PDCCH, a PDSCH, or a CSI-RS) on sub-band #2. As shown in FIG. 6, since PUCCH resource 621 overlaps symbols 631, the PUCCH transmission may be deferred.

In some embodiments, the symbol not intended for UL transmission may be a symbol configured to receive a downlink transmission (e.g., a PDCCH, PDSCH, or CSI-RS), which satisfies a certain condition(s).

In some examples, the symbol not intended for UL transmission may be a symbol configured to receive a downlink transmission on sub-band #A2 which schedules system information. For instance, the UE may be configured to receive a PDCCH in a CORESET associated with a Type0-PDCCH CSS set. In the event that a PUCCH transmission carrying HARQ-ACK feedback for an SPS PDSCH on sub-band #A1 overlaps a symbol for receiving such PDCCH, the PUCCH transmission may be deferred.

In some examples, the symbol not intended for UL transmission may be a symbol configured to receive a downlink transmission on sub-band #A2 which has a higher priority than the PUCCH transmission carrying the HARQ-ACK feedback for an SPS PDSCH on sub-band #A1. For example, the priority of the PUCCH transmission may correspond to that of the corresponding SPS configuration. In the event that the PUCCH transmission on sub-band #A1 overlaps a symbol for receiving a downlink transmission which has a higher priority, the PUCCH transmission may be deferred.

In some examples, a BS may indicate whether the PUCCH transmission is deferred or not when the PUCCH transmission on sub-band #A1 overlaps a symbol not intended for UL transmission on sub-band #A2. For example, in the event that the PUCCH transmission carrying the HARQ-ACK feedback for an SPS PDSCH on sub-band #A1 overlaps a symbol for receiving a downlink transmission on sub-band #A2 and the BS indicating a PUCCH deferral, the PUCCH transmission may be deferred.

In some examples, the symbol not intended for UL transmission may be a symbol configured to receive a downlink transmission on sub-band #A2, the starting symbol of which precedes that of the PUCCH transmission carrying the HARQ-ACK feedback for an SPS PDSCH on sub-band #A1. For example, in the event that the starting symbol of a downlink transmission reception on sub-band #A2 precedes the PUCCH transmission on sub-band #A1, and the PUCCH transmission on sub-band #A1 overlaps a symbol of the downlink transmission reception on sub-band #A2, the PUCCH transmission may be deferred.

In some embodiments, the symbol not intended for UL transmission may be a symbol configured for a downlink transmission, and configured to receive an SSB or a downlink transmission on sub-band #A2.

For example, assuming that a symbol may be indicated as downlink by tdd-UL-DL-ConfigurationCommon or tdd-UL-DL-ConfigurationDedicated on sub-band #A2, and the PUCCH transmission carrying the HARQ-ACK feedback for an SPS PDSCH on sub-band #A1 overlaps the symbol, the PUCCH transmission may be transmitted without deferral when the UE is not configured to receive a downlink transmission (e.g., a PDCCH, PDSCH, or CSI-RS) in this symbol on sub-band #A2 or this symbol is not from a set of symbols that is indicated to the UE for reception of SS/PBCH blocks on sub-band #A2. Otherwise, the PUCCH transmission may be deferred when the UE is configured to receive a downlink transmission in this symbol on sub-band #A2 or this symbol is configured to receive an SSB on sub-band #A2.

The definitions of the symbol not intended for a UL transmission in various embodiments may be used separately or in any combination. For example, a symbol not intended for a UL transmission may be defined as including only the symbol configured to receive an SSB. For example, a symbol not intended for a UL transmission may be defined as including only the symbol configured to receive a downlink transmission. For example, a symbol not intended for a UL transmission may be defined as including not only the symbol configured to receive an SSB but also the symbol configured to receive a downlink transmission.

When a PUCCH is deferred in a certain scenario, including but not limited to those as described above, embodiments of the present disclosure further provide methods for determining a target slot for the deferred PUCCH.

In some embodiments of the present disclosure, when a PUCCH carrying HARQ-ACK feedback for an SPS PDSCH in a slot is deferred, the UE may determine a PUCCH resource in an earliest target slot for transmitting the deferred PUCCH transmission. For example, the UE may check from the next slot of the slot per each slot until finding a suitable slot.

The PUCCH resource in a slot should satisfy a certain condition(s) so that the slot and the PUCCH resource can be selected as the target slot and target PUCCH resource. For example, in the event that a PUCCH resource in a slot on a frequency domain part (e.g., FDP #A1) does not overlap any symbol not intended for a UL transmission in the slot on another frequency domain part (e.g., FDP #A2), the PUCCH resource may be used for transmitting the deferred PUCCH. In some examples, at least a part of the HARQ-ACK information bits carried on the deferred PUCCH may be transmitted on the target PUCCH resource. Similar to the embodiments as described above, the at least part of the HARQ-ACK information bits may be determined based on a time difference between a target slot and the slot where the corresponding SPS PDSCH reception is received.

For example, in some embodiments of the present disclosure, in the event that a PUCCH resource in a slot on a serving cell of the plurality of serving cells of a UE does not overlap any symbol not intended for UL transmission in the slot on another serving cell of the plurality of serving cells of the UE, the PUCCH resource in the slot can be used for transmitting the deferred PUCCH transmission.

In some embodiments of the present disclosure, in the event that a PUCCH resource in a slot on a sub-band of a UE does not overlap any symbol not intended for UL transmission on another sub-band of a UE, the PUCCH resource in the slot can be used for transmitting the deferred PUCCH transmission. A sub-band may be a BWP of a serving cell of a UE or a part of a BWP of a serving cell of the UE.

The description regarding the symbol not intended for a UL transmission as described above may also apply here. For example, the symbol not intended for a UL transmission may be at least one of the following:
the symbol configured to receive an SSB on the other frequency domain part;
the symbol configured for a downlink transmission on the other frequency domain part;
the symbol configured to receive a downlink transmission on the other frequency domain part;
the symbol configured to receive a downlink transmission on the other frequency domain part which schedules system information;
the symbol configured to receive a downlink transmission on the other frequency domain part which has a higher priority than the deferred PUCCH transmission;
the symbol configured to receive a downlink transmission on the other frequency domain part and the UE is configured to defer a PUCCH transmission which overlaps the symbol receiving the downlink transmission;
the symbol configured to receive a downlink transmission on the other frequency domain part, the starting symbol of which precedes that of the PUCCH resource; or
the symbol configured for a downlink transmission on the other frequency domain part and configured to receive an SSB or a downlink transmission on the another frequency domain part.

As described above, the frequency domain part (e.g., FDP #A1) and the other frequency domain part (e.g., FDP #A2) may be a serving cell of the UE, a BWP of a serving cell of the UE, or a part of a BWP of a serving cell of the UE. In some examples, FDP #A2 may be a reference cell for the symbol not intended for a UL transmission among a plurality of serving cells of the UE, and may be different from FDP #A1.

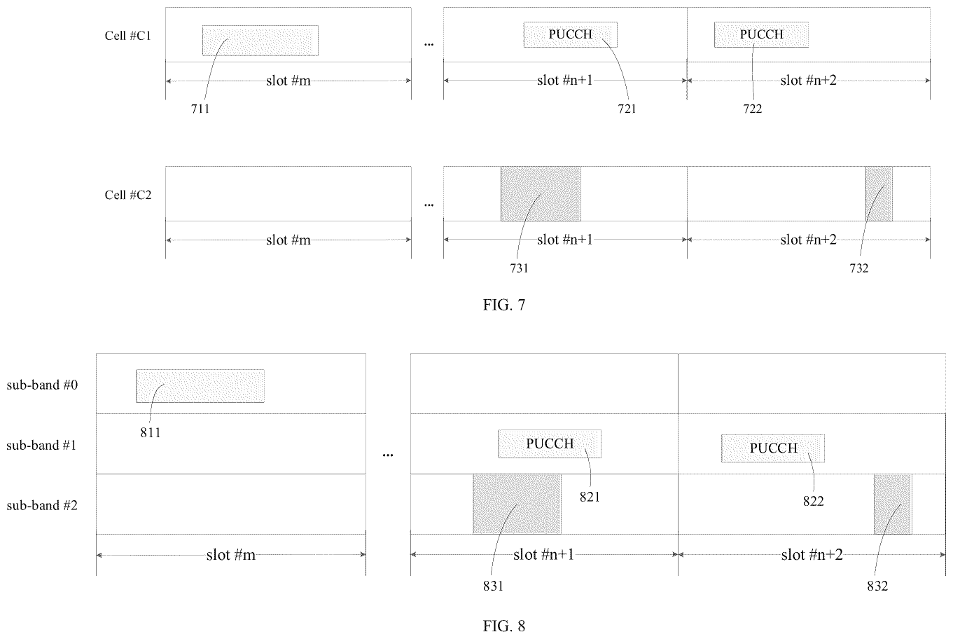

For example, referring to FIG. 7, a UE may be configured with a plurality of serving cells, including for example, cell #C1 and cell #C2. The UE may receive SPS PDSCH 711 in slot #m on cell #C1. In some circumstances, the PUCCH transmission with HARQ-ACK feedback for SPS PDSCH 711 may be deferred. The UE may find a target slot for transmitting the deferred PUCCH transmission.

For example, after performing the procedure to resolve overlapping among PUCCHs and PUSCHs, the UE may determine PUCCH resource 721 on cell #C1 in the earliest slot (e.g., in slot #n+1) to multiplex at least a part of the deferred HARQ-ACK information bits. Symbols 731 in slot #n+1 may be symbols not intended for a UL transmission on cell #C2. Since PUCCH resource 721 overlaps symbols 731, PUCCH resource 721 cannot be used for transmitting the deferred PUCCH transmission.

The UE may continue to find the target slot. For example, after performing the procedures to resolve overlapping among PUCCHs and PUSCHs, the UE may determine PUCCH resource 722 on cell #C1 in the earliest slot (e.g., in slot #n+2) to multiplex at least a part of the deferred HARQ-ACK information bits. Symbol 732 in slot #n+2 may be symbols not intended for a UL transmission on cell #C2. Since PUCCH resource 722 does not overlap symbol 732, PUCCH resource 722 can be used for transmitting the deferred PUCCH transmission.

For example, referring to FIG. 8, the BWP(s) of a serving cell of a UE may be divided into a plurality of sub-bands, including for example, sub-band #0, sub-band #1, and sub-band #2. The UE may receive SPS PDSCH 811 in slot #m on sub-band #0. In some circumstances, the PUCCH transmission with HARQ-ACK feedback for SPS PDSCH 811 may be deferred. The UE may find a target slot for transmitting the deferred PUCCH transmission.

For example, after performing the procedure to resolve overlapping among PUCCHs and PUSCHs, the UE may determine PUCCH resource 821 on sub-band #1 in the earliest slot (e.g., in slot #n+1) to multiplex at least a part of the deferred HARQ-ACK information bits. Symbols 831 in slot #n+1 may be symbols not intended for a UL transmission on sub-band #2. Since PUCCH resource 821 overlaps symbols 831, PUCCH resource 821 cannot be used for transmitting the deferred PUCCH transmission.

The UE may continue to find the target slot. For example, after performing the procedure to resolve overlapping among PUCCHs and PUSCHs, the UE may determine PUCCH resource 822 on sub-band #1 in the earliest slot (e.g., in slot #n+2) to multiplex at least a part of the deferred HARQ-ACK information bits. Symbol 832 in slot #n+2 may be symbols not intended for a UL transmission on sub-band #2. Since PUCCH resource 822 does not overlap symbol 832, PUCCH resource 822 can be used for transmitting the deferred PUCCH transmission.

It should be understood that the methods for target PUCCH resource determination in various embodiments may be used separately or in any combination. It should also be understood that the conditions for deferring a PUCCH transmission and the methods for target PUCCH resource determination as described above may be applied separately or in any combination. Although the embodiments in the present disclosure may be described with respect the time unit of slot, it is contemplated that the disclosed embodiments can also be applied to any other time unit, such as frame, sub-frame, mini-slot, sub-slot, or symbol.

In some embodiments of the present disclosure, a UE may defer HARQ-ACK feedback for an SPS PDSCH and determine a target slot for transmitting the deferred HARQ-ACK feedback according to the following pseudo-code.
If a UE is provided spsHARQdeferral by higher layer signaling and, after performing the procedures to resolve overlapping among PUCCHs and PUSCHs in a first slot, the UE determines a PUCCH resource for a PUCCH transmission with first HARQ-ACK information bits for SPS PDSCH receptions that the UE would report for a first time, and the PUCCH resource:
   is provided by SPS-PUCCH-AN-List by higher layer signaling, or by n1PUCCH-AN if SPS-PUCCH-AN-List is not provided, where SPS-PUCCH-AN-List and n1PUCCH-AN are used to configure a PUCCH resource for an SPS HARQ-ACK transmission only
   overlaps a symbol indicated as downlink by tdd-UL-DL-ConfigurationCommon or tdd-UL-DL-ConfigDedicated, or indicated for an SS/PBCH block by ssb-PositionsInBurst, or belonging to a CORESET associated with a Type0-PDCCH CSS set
   or in any of multiple serving cells, and overlaps symbols of a slot that are indicated to the UE for reception of SS/PBCH blocks in a first cell of the multiple serving cells by ssb-PositionsInBurst in SystemInformationBlockTypel or by ssb-PositionsInBurst in ServingCellConfigCommon, when provided to the UE, or overlaps a symbol indicated as downlink by tdd-UL-DL-ConfigurationCommon or tdd-UL-DL-ConfigurationDedicated on the reference cell, or overlaps symbol in which the UE is configured by higher layers to receive PDCCH, PDSCH, or CSI-RS on the reference cell, if the UE
      is configured with multiple serving cells and is provided half-duplex-behavior= ‘enable’, and
      is not capable of simultaneous transmission and reception on any of the multiple serving cells, and
      indicates support of capability for half-duplex operation in CA with unpaired spectrum, and
is not configured to monitor PDCCH for detection of DCI format 2_0 on any of the multiple serving cells, the UE:
   determines an earliest second slot and, after performing the procedures to resolve overlapping among PUCCHs and PUSCHs, a PUSCH or a PUCCH in the earliest second slot to multiplex HARQ-ACK information bits that include second HARQ-ACK information bits from the first HARQ-ACK information bits
      if the UE detects a DCI format in a PDCCH reception that triggers a PUCCH transmission with a Type-3 HARQ-ACK codebook in a slot, the UE stops the procedure to determine the earliest second slot
      if the UE is provided a periodic cell switching pattern for PUCCH transmissions by pucch-sSCellPattern, the UE determines the earliest second slot and a corresponding cell based on the periodic cell switching pattern
   the second HARQ-ACK information bits correspond to SPS PDSCH configurations with spsHARQdeferral values that are larger than or equal to a time difference, with reference to slots for PUCCH transmissions on the primary cell, between the second slot and the slot of the SPS PDSCH reception, if any
   the PUCCH
      does not have any symbol that overlaps a symbol indicated as downlink by tdd-UL-DL-ConfigurationCommon or tdd-UL-DL-ConfigDedicated, or indicated for an SS/PBCH block by ssb-PositionsInBurst, or belonging to a CORESET associated with a Type0-PDCCH CSS set, if the resource of the PUCCH is provided by SPS-PUCCH-AN-List, or by n1PUCCH-AN if SPS-PUCCH-AN-List is not provided
      or in any of multiple serving cells, and does not have any symbol that overlaps symbols of a slot that are indicated to the UE for reception of SS/PBCH blocks in a first cell of the multiple serving cells by ssb-PositionsInBurst in SystemInformationBlockTypel or by ssb-PositionsInBurst in ServingCellConfigCommon, when provided to the UE, or does not have any symbol that overlaps symbol indicated as downlink by tdd-UL-DL-ConfigurationCommon or tdd-UL-DL-ConfigurationDedicated on the reference cell, or does not have any symbol that overlaps symbol in which the UE is configured by higher layers to receive PDCCH, PDSCH, or CSI-RS on the reference cell, if the UE
         is configured with multiple serving cells and is provided half-duplex-behavior= ‘enable’, and
         is not capable of simultaneous transmission and reception on any of the multiple serving cells, and
         indicates support of capability for half-duplex operation in CA with unpaired spectrum, and
         is not configured to monitor PDCCH for detection of DCI format 2_0 on any of the multiple serving cells
   the second HARQ-ACK information bits, are appended in a HARQ-ACK codebook the UE generates
      if the UE receives a PDSCH providing a TB for a same HARQ process as a HARQ-ACK information bit from the second HARQ-ACK information bits prior to transmitting the PUCCH or the PUSCH, the UE does not include the HARQ-ACK information bit in the HARQ-ACK information bits.

In some embodiments of the present disclosure, a UE may defer HARQ-ACK feedback for an SPS PDSCH and determine a target slot for transmitting the deferred HARQ-ACK feedback according to the following pseudo-code.
If a UE is provided spsHARQdeferral by higher layer signaling and, after performing the procedures to resolve overlapping among PUCCHs and PUSCHs in a first slot, the UE determines a PUCCH resource for a PUCCH transmission with first HARQ-ACK information bits for SPS PDSCH receptions that the UE would report for a first time, and the PUCCH resource:
   is provided by SPS-PUCCH-AN-List by higher layer signaling, or by n1PUCCH-AN if SPS-PUCCH-AN-List is not provided, where SPS-PUCCH-AN-List and n1PUCCH-AN are used to configure a PUCCH resource for an SPS HARQ-ACK transmission only
   overlaps a symbol indicated as downlink by tdd-UL-DL-ConfigurationCommon or tdd-UL-DL-ConfigDedicated, or indicated for an SS/PBCH block by ssb-PositionsInBurst, or belonging to a CORESET associated with a Type0-PDCCH CSS set
      or is in one sub-band, and overlaps a symbol indicated as downlink by tdd-UL-DL-ConfigurationCommon or tdd-UL-DL-ConfigDedicated on another sub-band, or indicated for an SS/PBCH block by ssb-PositionsInBurst on another sub-band, or belonging to a CORESET associated with a Type0-PDCCH CSS set on another sub-band, or overlaps a symbol in which the UE is configured by higher layers to receive PDCCH, PDSCH, or CSI-RS on another sub-band
      or is in one sub-band, if at least one of the following rules is met, overlaps a symbol in which the UE is configured by higher layers to receive PDCCH, PDSCH, or CSI-RS on another sub-band, if the configured PDCCH is in a CORESET associated with a Type0-PDCCH CSS set;
         if the configured PDCCH, PDSCH, or CSI-RS on another sub-band has a higher priority;
         the BS indicates the PUCCH could not be transmitted by higher layer signaling; or
         the starting symbol of PDCCH, PDSCH, or CSI-RS is before the starting symbol of PUCCH the UE:
   determines an earliest second slot and, after performing the procedures to resolve overlapping among PUCCHs and PUSCHs, a PUSCH or a PUCCH in the earliest second slot to multiplex HARQ-ACK information bits that include second HARQ-ACK information bits from the first HARQ-ACK information bits
      if the UE detects a DCI format in a PDCCH reception that triggers a PUCCH transmission with a Type-3 HARQ-ACK codebook in a slot, the UE stops the procedure to determine the earliest second slot
      if the UE is provided a periodic cell switching pattern for PUCCH transmissions by pucch-sSCellPattern, the UE determines the earliest second slot and a corresponding cell based on the periodic cell switching pattern
   the second HARQ-ACK information bits correspond to SPS PDSCH configurations with spsHARQdeferral values that are larger than or equal to a time difference, with reference to slots for PUCCH transmissions on the primary cell, between the second slot and the slot of the SPS PDSCH reception, if any
   the PUCCH does not have any symbol that overlaps a symbol indicated as downlink by tdd-UL-DL-ConfigurationCommon or tdd-UL-DL-ConfigDedicated, or indicated for an SS/PBCH block by ssb-PositionsInBurst, or belonging to a CORESET associated with a Type0-PDCCH CSS set, if the resource of the PUCCH is provided by SPS-PUCCH-AN-List, or by n1PUCCH-AN if SPS-PUCCH-AN-List is not provided
      or is in one sub-band, and does not have any symbol that overlaps a symbol indicated as downlink by tdd-UL-DL-ConfigurationCommon or tdd-UL-DL-ConfigDedicated on another sub-band, or indicated for an SS/PBCH block by ssb-PositionsInBurst on another sub-band, or belonging to a CORESET associated with a Type0-PDCCH CSS set on another sub-band, or that overlaps a symbol in which the UE is configured by higher layers to receive PDCCH, PDSCH, or CSI-RS on another sub-band,
      or is in one sub-band, if at least one of the following rules is met, overlaps a symbol in which the UE is configured by higher layers to receive PDCCH, PDSCH, or CSI-RS on another sub-band,
         if the configured PDCCH is not in a CORESET associated with a Type0-PDCCH CSS set;
         if the configured PDCCH, PDSCH, or CSI-RS on another sub-band has a lower priority;
         the BS indicates the PUCCH could be transmitted by higher layer signaling;
         the starting symbol of PDCCH, PDSCH, or CSI-RS is later the starting symbol of PUCCH
   the second HARQ-ACK information bits, are appended in a HARQ-ACK codebook the UE generates
      if the UE receives a PDSCH providing a TB for a same HARQ process as a HARQ-ACK information bit from the second HARQ-ACK information bits prior to transmitting the PUCCH or the PUSCH, the UE does not include the HARQ-ACK information bit in the HARQ-ACK information bits.

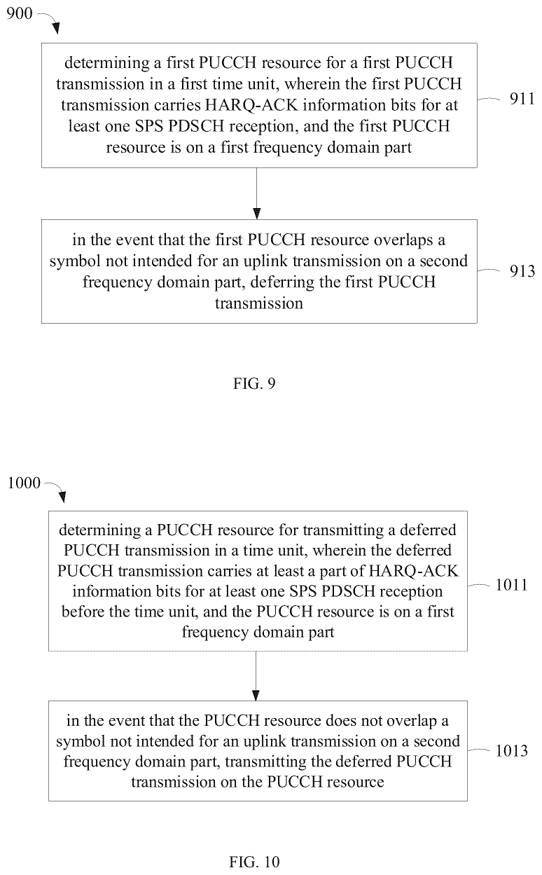

FIG. 9 illustrates a flow chart of an exemplary procedure 900 for wireless communications in accordance with some embodiments of the present disclosure. Details described in all of the foregoing embodiments of the present disclosure are applicable for the embodiments shown in FIG. 9. In some examples, the procedure may be performed by a UE, for example, UE 101 in FIG. 1.

Referring to FIG. 9, in operation 911, a UE may determine a first PUCCH resource for a first PUCCH transmission in a first time unit, wherein the first PUCCH transmission may carry HARQ-ACK information bits for at least one SPS PDSCH reception, and the first PUCCH resource may be on a first frequency domain part.

In operation 913, the UE may defer the first PUCCH transmission in the event that the first PUCCH resource overlaps a symbol not intended for an uplink transmission on a second frequency domain part.

In some embodiments of the present disclosure, the first frequency domain part and the second frequency domain part are each one of a serving cell of the UE, a sub-band, a BWP of a serving cell of the UE, or a part of a BWP of a serving cell of the UE.

In some embodiments of the present disclosure, the second frequency domain part may be a reference cell for the symbol among a plurality of serving cells of the UE. The first frequency domain part may be a serving cell of the UE different from the reference cell.

In some embodiments of the present disclosure, the symbol not intended for an uplink transmission on the second frequency domain part may include at least one of the following: a symbol configured to receive a synchronization signal block (SSB) on the second frequency domain part; a symbol configured for a downlink transmission on the second frequency domain part; a symbol configured to receive a downlink transmission on the second frequency domain part; a symbol configured to receive a downlink transmission on the second frequency domain part which schedules system information; a symbol configured to receive a downlink transmission on the second frequency domain part which has a higher priority than the first or second PUCCH transmission; a symbol configured to receive a downlink transmission on the second frequency domain part and the UE configured to defer a PUCCH transmission which overlaps the symbol receiving the downlink transmission; a symbol configured to receive a downlink transmission on the second frequency domain part, the starting symbol of which precedes that of the first or second PUCCH resource; or a symbol configured for a downlink transmission on the second frequency domain part and configured to receive an SSB or a downlink transmission on the second frequency domain part.

In some embodiments of the present disclosure, the UE may determine a target PUCCH resource for transmitting the deferred HARQ-ACK information bits according to various embodiments as disclosure herein. For example, the UE may determine a second PUCCH resource for a second PUCCH transmission in a second time unit after the first time unit. The second PUCCH transmission may carry at least a part of the HARQ-ACK information bits, and the second PUCCH resource may be on a third frequency domain part. The UE may transmit the second PUCCH transmission on the second PUCCH resource in the event that the second PUCCH resource does not overlap a symbol not intended for an uplink transmission on a fourth frequency domain part.

In some embodiments of the present disclosure, the third frequency domain part and the fourth frequency domain part may be a serving cell of the UE, a sub-band, a BWP of a serving cell of the UE, or a part of a BWP of a serving cell of the UE. In some embodiments of the present disclosure, the at least part of the HARQ-ACK information bits may be determined based on a time difference between the second time unit and a time unit where a corresponding SPS PDSCH reception is received.

In some embodiments of the present disclosure, the UE may determine that a symbol is not intended for an uplink transmission on the fourth frequency domain part in the event of at least one of the following: the symbol is configured to receive an SSB on the fourth frequency domain part; the symbol is configured for a downlink transmission on the fourth frequency domain part; the symbol is configured to receive a downlink transmission on the fourth frequency domain part; the symbol is configured to receive a downlink transmission on the fourth frequency domain part which schedules system information; the symbol is configured to receive a downlink transmission on the fourth frequency domain part which has a higher priority than the first or second PUCCH transmission; the symbol is configured to receive a downlink transmission on the fourth frequency domain part and the UE is configured to defer a PUCCH transmission which overlaps the symbol receiving the downlink transmission; the symbol is configured to receive a downlink transmission on the fourth frequency domain part, the starting symbol of which precedes that of the first or second PUCCH resource; or the symbol is configured for a downlink transmission on the fourth frequency domain part and is configured to receive an SSB or a downlink transmission on the fourth frequency domain part.

It should be appreciated by persons skilled in the art that the sequence of the operations in exemplary procedure 900 may be changed and some of the operations in exemplary procedure 900 may be eliminated or modified, without departing from the spirit and scope of the disclosure.

FIG. 10 illustrates a flow chart of an exemplary procedure 1000 for wireless communications in accordance with some embodiments of the present disclosure. Details described in all of the foregoing embodiments of the present disclosure are applicable for the embodiments shown in FIG. 10. In some examples, the procedure may be performed by a UE, for example, UE 101 in FIG. 1.

Referring to FIG. 10, in operation 1011, a UE may determine a PUCCH resource for transmitting a deferred PUCCH transmission in a time unit, wherein the deferred PUCCH transmission may carry at least a part of HARQ-ACK information bits for at least one SPS PDSCH reception before the time unit, and the PUCCH resource may be on a first frequency domain part. The PUCCH transmission may be deferred by the UE under various circumstances as described in the text of the present disclosure.

In operation 1013, the UE may transmit the deferred PUCCH transmission on the PUCCH resource in the event that the PUCCH resource does not overlap a symbol not intended for an uplink transmission on a second frequency domain part.

In some embodiments of the present disclosure, the first frequency domain part and the second frequency domain part may each be one of a serving cell of the UE, a sub-band, a BWP of a serving cell of the UE, or a part of a BWP of a serving cell of the UE. In some embodiments of the present disclosure, the second frequency domain part may be a reference cell for the symbol among a plurality of serving cells of the UE. The first frequency domain part may be a serving cell of the UE different from the reference cell. In some embodiments of the present disclosure, the at least part of the HARQ-ACK information bits may be determined based on a time difference between the time unit and a time unit where a corresponding SPS PDSCH reception is received.

In some embodiments of the present disclosure, the UE may determine that the symbol is not intended for an uplink transmission on the second frequency domain part in the event of at least one of the following: the symbol is configured to receive an SSB on the second frequency domain part; the symbol is configured for a downlink transmission on the second frequency domain part; the symbol is configured to receive a downlink transmission on the second frequency domain part; the symbol is configured to receive a downlink transmission on the second frequency domain part which schedules system information; the symbol is configured to receive a downlink transmission on the second frequency domain part which has a higher priority than the deferred PUCCH transmission; the symbol is configured to receive a downlink transmission on the second frequency domain part and the UE is configured to defer a PUCCH transmission which overlaps the symbol receiving the downlink transmission; the symbol is configured to receive a downlink transmission on the second frequency domain part, the starting symbol of which precedes that of the PUCCH resource; or the symbol is configured for a downlink transmission on the second frequency domain part and is configured to receive an SSB or a downlink transmission on the second frequency domain part.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

FIG. 11 illustrates a block diagram of an exemplary apparatus 1100 according to some embodiments of the present disclosure. As shown in FIG. 11, the apparatus 1100 may include at least one processor 1106 and at least one transceiver 1102 coupled to the processor 1106. The apparatus 1100 may be a UE or a BS.

Although in this figure, elements such as the at least one transceiver 1102 and processor 1106 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory, and/or other components.

In some embodiments of the present application, the apparatus 1100 may be a UE. The transceiver 1102 and the processor 1106 may interact with each other so as to perform the operations with respect to the UE described in FIGS. 1-10.

In some embodiments of the present application, the apparatus 1100 may further include at least one non-transitory computer-readable medium. For example, in some embodiments of the present disclosure, the non-transitory computer-readable medium may have stored thereon computer-executable instructions to cause the processor 1106 to implement the method with respect to the UE as described above. For example, the computer-executable instructions, when executed, cause the processor 1106 interacting with transceiver 1102 to perform the operations with respect to the UE described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, the UE comprising:
a memory;
a transceiver; and
a processor coupled to the memory and to the transceiver, wherein the processor is configured to cause the UE to:
determine a first physical uplink control channel (PUCCH) resource for a first PUCCH transmission in a first time unit, wherein the first PUCCH transmission carries hybrid automatic repeat request acknowledgement (HARQ-ACK) information bits for at least one semi-persistent scheduling (SPS) physical downlink shared channel (PDSCH) reception, and the first PUCCH resource is on a first frequency domain part; and
in the event that the first PUCCH resource overlaps a symbol not intended for an uplink transmission on a second frequency domain part, defer the first PUCCH transmission.

2. The UE of claim 1, wherein the first frequency domain part and the second frequency domain part are each one of a serving cell of the UE, a bandwidth part (BWP) of a serving cell of the UE, or a part of a BWP of a serving cell of the UE.

3. The UE of claim 1, wherein the second frequency domain part is a reference cell for the symbol among a plurality of serving cells of the UE, and the first frequency domain part is a serving cell of the UE different from the reference cell.

4. The UE of claim 1, wherein the processor is further configured to:
determine a second PUCCH resource for a second PUCCH transmission in a second time unit after the first time unit, wherein the second PUCCH transmission carries at least a part of the HARQ-ACK information bits, and the second PUCCH resource is on a third frequency domain part; and
in the event that the second PUCCH resource does not overlap a symbol not intended for an uplink transmission on a fourth frequency domain part, transmit the second PUCCH transmission on the second PUCCH resource.

5. The UE of claim 4, wherein the third frequency domain part and the fourth frequency domain part are each one of a serving cell of the UE, a bandwidth part (BWP) of a serving cell of the UE, or a part of a BWP of a serving cell of the UE.

6. The UE of claim 4, wherein the at least part of the HARQ-ACK information bits is determined based on a time difference between the second time unit and a time unit where a corresponding SPS PDSCH reception is received.

7. The UE of claim 1 or 4, wherein the processor is further configured to determine that a symbol is not intended for an uplink transmission on the second or fourth frequency domain part in the event of at least one of the following:
the symbol is configured to receive a synchronization signal block (SSB) on the second or fourth frequency domain part;
the symbol is configured for a downlink transmission on the second or fourth frequency domain part;
the symbol is configured to receive a downlink transmission on the second or fourth frequency domain part;
the symbol is configured to receive a downlink transmission on the second or fourth frequency domain part which schedules system information;
the symbol is configured to receive a downlink transmission on the second or fourth frequency domain part which has a higher priority than the first or second PUCCH transmission;
the symbol is configured to receive a downlink transmission on the second or fourth frequency domain part and the UE is configured to defer a PUCCH transmission which overlaps the symbol receiving the downlink transmission;
the symbol is configured to receive a downlink transmission on the second or fourth frequency domain part, the starting symbol of which precedes that of the first or second PUCCH resource; or
the symbol is configured for a downlink transmission on the second or fourth frequency domain part and is configured to receive an SSB or a downlink transmission on the second or fourth frequency domain part.

8. A user equipment (UE) for wireless communication, the UE comprising:
a memory;
a transceiver; and
a processor coupled to the memory and to the transceiver, wherein the processor is configured to cause the UE to:
determine a physical uplink control channel (PUCCH) resource for transmitting a deferred PUCCH transmission in a time unit, wherein the deferred PUCCH transmission carries at least a part of hybrid automatic repeat request acknowledgement (HARQ-ACK) information bits for at least one semi-persistent scheduling (SPS) physical downlink shared channel (PDSCH) reception before the time unit, and the PUCCH resource is on a first frequency domain part; and
in the event that the PUCCH resource does not overlap a symbol not intended for an uplink transmission on a second frequency domain part, transmit the deferred PUCCH transmission on the PUCCH resource.

9. The UE of claim 8, wherein the first frequency domain part and the second frequency domain part are each one of a serving cell of the UE, a bandwidth part (BWP) of a serving cell of the UE, or a part of a BWP of a serving cell of the UE.

10. The UE of claim 8, wherein the second frequency domain part is a reference cell for the symbol among a plurality of serving cells of the UE, and the first frequency domain part is a serving cell of the UE different from the reference cell.

11. The UE of claim 8, wherein the at least part of the HARQ-ACK information bits is determined based on a time difference between the time unit and a time unit where a corresponding SPS PDSCH reception is received.

12. The UE of claim 8, wherein the processor is further configured to determine that the symbol is not intended for an uplink transmission on the second frequency domain part in the event of at least one of the following:
the symbol is configured to receive a synchronization signal block (SSB) on the second frequency domain part;
the symbol is configured for a downlink transmission on the second frequency domain part;
the symbol is configured to receive a downlink transmission on the second frequency domain part;
the symbol is configured to receive a downlink transmission on the second frequency domain part which schedules system information;
the symbol is configured to receive a downlink transmission on the second frequency domain part which has a higher priority than the deferred PUCCH transmission;
the symbol is configured to receive a downlink transmission on the second frequency domain part and the UE is configured to defer a PUCCH transmission which overlaps the symbol receiving the downlink transmission;
the symbol is configured to receive a downlink transmission on the second frequency domain part, the starting symbol of which precedes that of the PUCCH resource; or
the symbol is configured for a downlink transmission on the second frequency domain part and is configured to receive an SSB or a downlink transmission on the second frequency domain part.

13. A method performed by a user equipment (UE), the method comprising:
determining a first physical uplink control channel (PUCCH) resource for a first PUCCH transmission in a first time unit, wherein the first PUCCH transmission carries hybrid automatic repeat request acknowledgement (HARQ-ACK) information bits for at least one semi-persistent scheduling (SPS) physical downlink shared channel (PDSCH) reception, and the first PUCCH resource is on a first frequency domain part; and
in the event that the first PUCCH resource overlaps a symbol not intended for an uplink transmission on a second frequency domain part, deferring the first PUCCH transmission.

14. The method of claim 13, further comprising:
determining a second PUCCH resource for a second PUCCH transmission in a second time unit after the first time unit, wherein the second PUCCH transmission carries at least a part of the HARQ-ACK information bits, and the second PUCCH resource is on a third frequency domain part; and
in the event that the second PUCCH resource does not overlap a symbol not intended for an uplink transmission on a fourth frequency domain part, transmitting the second PUCCH transmission on the second PUCCH resource.

15. The method of claim 13, wherein the first frequency domain part and the second frequency domain part are each one of a serving cell of the UE, a bandwidth part (BWP) of a serving cell of the UE, or a part of a BWP of a serving cell of the UE.

16. The method of claim 17, wherein the second frequency domain part is a reference cell for the symbol among a plurality of serving cells of the UE, and the first frequency domain part is a serving cell of the UE different from the reference cell.

17. The method of claim 13, further comprising determining the at least part of the HARQ-ACK information bits based on a time difference between the second time unit and a time unit where a corresponding SPS PDSCH reception is received.

18. A method performed by a user equipment (UE), the method comprising:
determining a physical uplink control channel (PUCCH) resource for transmitting a deferred PUCCH transmission in a time unit, wherein the deferred PUCCH transmission carries at least a part of hybrid automatic repeat request acknowledgement (HARQ-ACK) information bits for at least one semi-persistent scheduling (SPS) physical downlink shared channel (PDSCH) reception before the time unit, and the PUCCH resource is on a first frequency domain part; and
in the event that the PUCCH resource does not overlap a symbol not intended for an uplink transmission on a second frequency domain part, transmitting the deferred PUCCH transmission on the PUCCH resource.

19. The method of claim 17, wherein the first frequency domain part and the second frequency domain part are each one of a serving cell of the UE, a bandwidth part (BWP) of a serving cell of the UE, or a part of a BWP of a serving cell of the UE.

20. The method of claim 17, further comprising determining the at least part of the HARQ-ACK information bits based on a time difference between the time unit and a time unit where a corresponding SPS PDSCH reception is received.
